(19) United States
(12) Patent Application Publication
(10) Pub. No.: US 2016/0199968 A1
(43) Pub. Date: Jul. 14, 2016

(54) HAMMER

(71) Applicants: Hangzhou Great Star Industrial Co., Ltd, Zhejiang Province (CN); Hangzhou Great Star Tools Co., Ltd, Zhejiang Province (CN)

(72) Inventors: Wentian Yu, Zhejiang Province (CN); Alex Ogle, Mooresville, NC (US); Andy Pardue, Mooresville, NC (US); Daniel Lyalls, Mooresville, NC (US); Scott Suttle, Mooresville, NC (US); Jay Fording, Mooresville, NC (US)

(21) Appl. No.: 13/876,687

(22) PCT Filed: Jan. 6, 2013
(86) PCT No.: PCT/CN2013/070133

§ 371 Date: Mar. 28, 2013

(51) Int. Cl. B25D 1/00; B25G 1/10

(52) U.S. Cl. CPC B25D 1/00; B25G 1/10

(57) ABSTRACT

A hammer comprising a handle and a hammer head. The hammer head includes an integrally molded crash-proof portion therewith that extends downwardly from an initial surface and at least partially wraps the side of the handle beneath the striking face of the hammer head, wherein the initial surface is a surface coinciding the interface between the hammer head and the handle of an ordinary hammer.

### FIELD OF THE INVENTION

The present invention relates to a hammer, and pertains to the field of hand tools.

### DESCRIPTION OF THE PRIOR ART

Hammer is a kind of simple tool used widely, typically comprising a hammer head made of steel or other metal and a handle made of wood or other composite material such as fiberglass. An end of the hammer head is a striking portion having a striking face, and the other end is generally a claw portion for drawing out a nail. A mortise is provided in the midst of the hammer head, and an end of the handle can be inserted into the mortise of the hammer head by interference fit, so that the hammer head and the handle can be jointly secured.

When a hammer is used to strike an object to be struck such as an iron nail, there can be chances that the striking face of the hammer fails to hit the object to be struck accurately but makes the object to be struck hit against the handle under the hammer head, which may cause injury of the handle, detachment of the handle from the hammer head, and in serious occasions even may directly lead to a breakage at the joint of the hammer head and the handle, largely shortening the service life of the hammer.

### SUMMARY OF THE INVENTION

In view of the above defects existing in the prior art, an object of the present invention is to solve the technical problem by providing a hammer which can prevent the circumstance that the object to be struck is not hit accurately by the striking face of the hammer head, but is hit by the handle, which would bring damage and invalidity to the hammer.

In order to accomplish the above object, the present invention provides a hammer comprising a handle and a hammer head, wherein the hammer head comprises an integrally molded crash-proof portion therewith extending downwardly from the initial surface thereof at least partially wrappings the side of the handle beneath the striking face of the hammer head, wherein the initial surface is a surface coinciding the interface between the hammer head and the handle of an ordinary hammer.

In a preferred embodiment of the present invention, the periphery of the striking face has a first point in the lowest position, the crash-proof portion extends from the initial surface to a second point, and an included angle α between the line connected the first point to the second point and a horizontal plane across through the first point is less than or equal to 55°.

In another preferred embodiment of the present invention, the length L of the crash-proof portion extending downwardly from the initial surface is no less than the diameter D of the striking face and no greater than 1.5D.

In another preferred embodiment of the present invention, the thickness W of the crash-proof portion (23) is greater than 2 mm.

In another preferred embodiment of the present invention, an included angle formed between two tangent lines respectively across through the central point of the cross section of the handle and both end of the crash-proof portion is greater than or equal to 65° and less than or equal to 90°.

In another preferred embodiment of the present invention, the tip of the handle has an anti-detaching nail driven into.

In another preferred embodiment of the present invention, the mortise set in the midst of the hammer head is arranged with an inverted cone angle at the open side of the top face of the hammer head.

When the striking face fails to hit the object to be struck accurately, the crash-proof portion can protect the handle from the direct impact force from the object to be struck, and the integration of the crash-proof portion with the hammer head may help to enhance the strength of the crash-proof portion, and facilitate production and manufacture as well.

Hereinafter more detailed description will be made by incorporating figures to illustrate the conception, concrete structure and technical effect of the present invention for an adequate understanding of the object, features and effects of the present invention.

### BRIEF DESCRIPTION OF THE DRAWINGS

FIG. 1 is a part sectional view of a hammer in a preferred embodiment of the present invention;

FIG. 2 is a sectional view of a hammer head of an ordinary hammer;

FIG. 3 is a sectional view of a hammer head of a hammer in a preferred embodiment of the present invention;

FIG. 4 is a sectional view of a hammer head of a hammer in a preferred embodiment of the present invention; and

FIG. 5 is a cross-sectional view of a crash-proof portion of a hammer in an embodiment of the present invention.

### DETAILED DESCRIPTION OF THE PREFERRED EMBODIMENTS

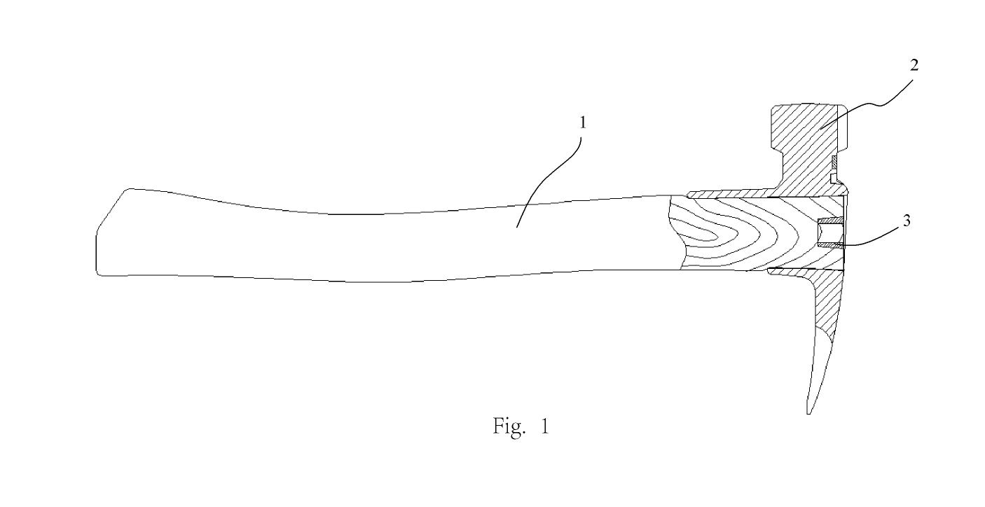

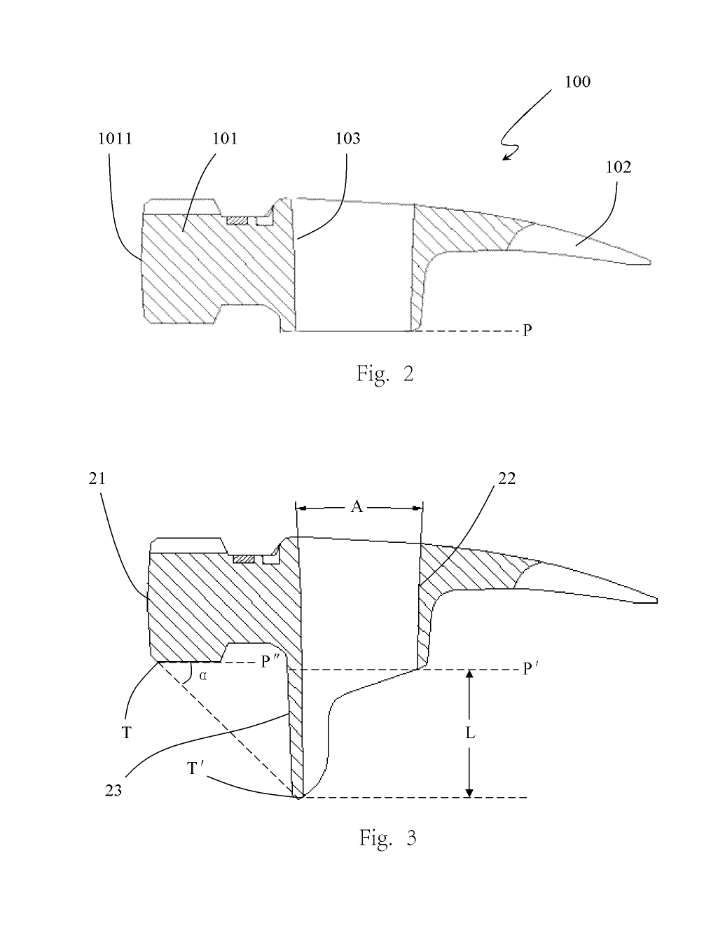

FIG. 2 illustrates a conventional hammer head 100 in the prior art. An end of the hammer head 100 is a striking portion 101 of cylindrical shape, while the other end is a claw portion 102, and the slightly protruding end face of the striking portion 101 is a striking face 1011. The midst of the hammer 100 is arranged with a mortise 103. As shown in FIG. 1, the ordinary hammer has an interface P between the hammer head 100 and the handle, and the portion of the handle that is above the interface P engaged within the mortise 103, while the portion of the handle beneath the interface P exposes outside. As the impact force received by the hammer being struck is concentrated at the interface P, and especially when the striking face 1011 fails to hit the object to be struck and exert the impact force directly to the handle, the interface P is the vulnerable part of the ordinary hammer, and easily be broken.

FIG. 1 shows a hammer according to a specific embodiment of the present invention, comprising a handle 1 and a hammer head 2. As shown in FIG. 3, reference numeral 21 refers to the striking face of the hammer head 2 arranged with a mortise 22 in the midst, and the handle 2 is inserted into the mortise 22 by interference fit. Compared with the ordinary hammer head 100, the hammer head 2 in this embodiment also includes an integrally molded crash-proof portion 23 therewith that extends downwardly from an initial surface P′ and at least partially wraps the side of the handle beneath the striking face 21. Referring to FIG. 5, the initial surface P′ is a surface coinciding the interface P of the ordinary hammer, Referring to FIG. 2, when the striking face 21 fails to hit the object to be struck accurately, the crash-proof portion 23 can protect the handle 21 from the direct impact force from the object to be struck.

In this embodiment, the integration of the crash-proof portion with the hammer head may help to enhance the strength of the crash-proof portion, and facilitate production and manufacture as well.

In a preferred embodiment, as shown in FIG. 3, T refers a lowest point on the periphery of striking face 21 and the crash-proof portion 23 extends downwardly from the initial surface P′of length L to a point T′, so that a included angle α between the line connecting the point T to the point T′ of crash-proof portion 23 and a horizontal plane P″ across through the point T is no greater than 55°.

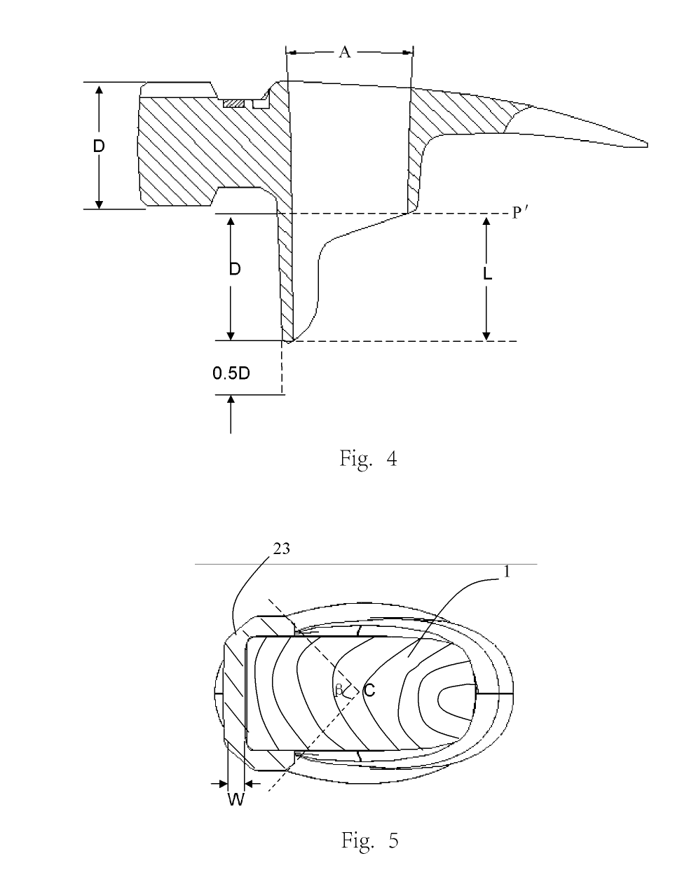

In another preferred embodiment, as shown in FIG. 4, the length L of the crash-proof portion 23 extending downwardly from the initial surface P′ is no less than diameter D of the striking face 21, and no greater than 1.5D.

In another preferred embodiment, as shown in FIG. 5, the thickness W of the crash-proof portion 23 is greater than 2 mm.

In another preferred embodiment, as shown in FIG. 5, an included angle β formed between two tangent lines respectively across through a central point C of the cross section of the handle 1 and both end of the crash-proof portion 23 is greater than or equal to 65° and less than or equal to 90°.

As shown in FIG. 1, in this embodiment or other embodiments, further, an anti-detaching nail 3 can be driven into the tip of the handle 1 to make it expand, which enables tighter fit between the handle 1 and the hammer head 2 so as to reduce the possibility of getting loose. Additionally, as shown in FIG. 3 and FIG. 4, the mortise 22 can be arranged with an inverted cone angle A at the open side of the top face of hammer head 2 so as to secure the handle in mortise 22 advantageously.

Preferred embodiments of the present invention have been described above. It should be understood that many modifications and variations can be made by ordinary technician of the field according to conception of present invention without creative labor. Therefore, all the technical schemes obtained through logical analysis, deductions or limited experimentation based on the present invention by technicians of the field are within the scope of the claims.

What is claimed is:

1. A hammer comprising a handle and a hammer head, wherein the hammer head comprises an integrally molded crash-proof portion therewith extending downwardly from an initial surface and at least partially wrapping the side of the handle beneath the striking face of the hammer head, wherein the initial surface is a surface coinciding the interface between the hammer head and the handle of an ordinary hammer.

2. The hammer as claimed in claim 1, wherein the periphery of the striking face has a first point in the lowest position, the crash-proof portion extends from the initial surface to a second point, and an included angle α between the line connecting the first point to the second point and a horizontal plane across through the first point is less than or equal to 55°.

3. The hammer as claimed in claim 1, wherein the length of the crash-proof portion extending downwardly from the initial surface is no less than the diameter D of the striking face and no greater than 1.5×D.

4. The hammer as claimed in claim 1, wherein the thickness W of the crash-proof portion is greater than 2 mm.

5. The hammer as claimed in claim 1, wherein an included angle β formed between two tangent lines respectively across through the central point of the cross section of handle and both end of the crash-proof portion, is greater than or equal to 65° and less than or equal to 90°.

6. The hammer as claimed in claim 1, wherein the tip of the handle has an anti-detaching nail driven thereinto.

7. The hammer as claimed in claim 1, wherein the mortise provided in the midst of the hammer head is arranged with an inverted cone angle at the open side of the top face of the hammer head.

8. The hammer as claimed in any of claims 2, wherein the thickness of the crash-proof portion is greater than 2 mm.

9. The hammer as claimed in any of claims 3, wherein the thickness of the crash-proof portion is greater than 2 mm.

10. The hammer as claimed in any of claims 2, wherein an included angle β formed between two tangent lines respectively across through the central point of the cross section of handle and both end of the crash-proof portion, is greater than or equal to 65° and less than or equal to 90°.

11. The hammer as claimed in any of claims 3, wherein an included angle β formed between two tangent lines respectively across through the central point of the cross section of handle and both end of the crash-proof portion, is greater than or equal to 65° and less than or equal to 90°.
